(19) United States
(12) Patent Application Publication
(10) Pub. No.: US 2026/0244678 A1
(43) Pub. Date: Aug. 20, 2026

(54) METHOD, APPARATUS, DEVICE AND STORAGE MEDIUM FOR VOLUME ADJUSTMENT

(71) Applicants: Beijing Zitiao Network Technology Co., Ltd., Beijing (CN); Lemon Inc., Grand Cayman (KY)

(72) Inventors: Xin Zhong, Singapore (SG); Chong Jiao, Beijing (CN); Zhendong Zhong, Beijing (CN); Pengyuan Du, Beijing (CN); Ning Lin, Singapore (SG); Shan Zhang, CULVER CITY, CA (US); Lan Xie, Beijing (CN); Shenglan Huang, Los Angeles, CA (US); Dian Yang, Singapore (SG)

(21) Appl. No.: 19/542,597

(22) Filed: Feb. 17, 2026

(30) Foreign Application Priority Data
Feb. 17, 2025 (WO) PCT/CN2025/077659

(51) Int. Cl. G06F 16/435

(52) U.S. Cl. CPC G06F 16/435

(57) ABSTRACT

A method, apparatus, device and storage medium for volume adjustment are provided. A method for volume adjustment includes: determining context information associated with a second media content during presentation of a first media content, the second media content being configured to be presented after the first media content; determining a processing strategy for a volume of the second media content based on at least one of the context information and reference information associated with the volume adjustment; and configuring the volume of the second media content based on the processing strategy.

### CROSS-REFERENCE

This application claims priority to Internation Application No. PCT/CN2025/077659, filed on February 17, 2025, and entitled “METHOD, APPARATUS, DEVICE AND STORAGE MEDIUM FOR VOLUME ADJUSTMENT”, which is incorporated herein by reference in its entirety.

### FIELD

Example embodiments of the present disclosure generally relate to the field of computers, and in particular, to a method, apparatus, device, and computer-readable storage medium for volume adjustment.

### BACKGROUND

With the rapid development of the Internet, more and more applications are designed to provide various services to users. For example, an application may provide a wide variety of media contents to a user. For example, the user may browse the media contents based on the application. In some scenarios, the user may have different requirements on the volume of the media contents.

### SUMMARY

In a first aspect of the present disclosure, a method for volume adjustment is provided. The method includes: determining context information associated with a second media content during presentation of a first media content, the second media content being configured to be presented after the first media content; determining a processing strategy for a volume of the second media content based on at least one of the context information and reference information associated with the volume adjustment; and configuring the volume of the second media content based on the processing strategy.

In a second aspect of the present disclosure, an apparatus for volume adjustment is provided. The apparatus includes: a context information determining module configured to determine context information associated with a second media content during presentation of a first media content, the second media content being configured to be presented after the first media content; a processing strategy determining module configured to determine a processing strategy for a volume of the second media content based on at least one of the context information and reference information associated with the volume adjustment; and a volume configuring module configured to configure the volume of the second media content based on the processing strategy.

In a third aspect of the present disclosure, an electronic device is provided. The electronic device includes at least one processor; and at least one memory coupled to the at least one processor and storing instructions for execution by the at least one processor, the instructions, when executed by the at least one processor, causing the electronic device to perform the method the first aspect.

In a fourth aspect of the present disclosure, a non-transitory computer-readable storage medium is provided. The non-transitory computer-readable storage medium has computer-executable instructions stored thereon, the instructions being executable by a processor to implement the method of the first aspect.

According to a fifth aspect of the present disclosure, a computer program product including computer-executable instructions is provided, wherein the computer-executable instructions, when executed by a processor, implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 shows a flowchart of a process for volume adjustment according to some embodiments of the present disclosure;

FIG. 3 illustrates a schematic diagram of an example architecture for performing volume adjustment with a classification model according to some embodiments of the present disclosure.

FIG. 4 shows a block diagram of an apparatus for volume adjustment according to some embodiments of the present disclosure; and

FIG. 5 illustrates a block diagram of a device capable of implementing one or more embodiments of the present disclosure.

### DETAILED DESCRIPTION

Embodiments of the present disclosure would be described in more detail below with reference to the accompanying drawings. While certain embodiments of the present disclosure are shown in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below.

Herein, unless explicitly stated, “in response to A” performs one step and does not imply that this step is performed immediately after “A”, but may include one or more intermediate steps.

It would be appreciated that the data involved in the technical solution (including but not limited to the data itself, the obtaining or use of the data) would follow the requirements of the corresponding laws and regulations and related regulations.

It would be appreciated that, before the technical solutions disclosed in the embodiments of the present disclosure are used, the types of personal information related to the present disclosure, the usage scope, the usage scenario and the like would be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user may autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “disagree” to provide personal information to the electronic device.

It would be appreciated that the foregoing notification and obtaining a user authorization process are merely illustrative, and do not constitute a limitation on implementations of the present disclosure, and other manners of satisfying related laws and regulations may also be applied to implementations of the present disclosure.

As briefly mentioned above, an application may provide a wide variety of media contents to a user. Conventionally, in a process of browsing a media content (for example, a video), a user may manually adjust a volume of the current media content when browsing different media contents. For example, in a scenario (hereinafter also referred to as a hybrid scenario) in which video-on-demand and live video stream are mixed, a user may continuously scroll down to browse new media contents (for example, video or live stream). In this process, the user may adjust the volume of the current media content by himself. However, by means of operation, the user needs to adjust the volume of the current media content by himself, thereby reducing the user experience.

In view of this, an improved solution for volume adjustment is provided by the present disclosure. According to aspects of the present disclosure, context information associated with a second media content is determined during presentation of a first media content, the second media content being configured to be presented after the first media content. Correspondingly, a processing strategy for a volume of the second media content is determined based on at least one of the context information and reference information associated with the volume adjustment. Further, the volume of the second media content is configured based on the processing strategy.

In this way, the volume required by the user in the next media content may be predicted in advance based on at least one of the context information and the reference information, so that the user does not need to adjust the volume automatically when watching the next media content. Further, the influence of the volume difference between different media contents on the user is reduced, and the user experience is improved.

Example embodiments of the present disclosure are described below with reference to the accompanying drawings.

### Example Environment

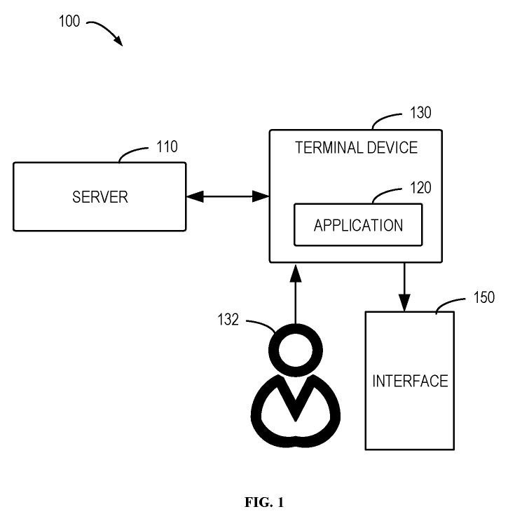

FIG. 1 illustrates a schematic diagram of an example environment 100 in which embodiments of the present disclosure may be implemented. In this example environment 100, an instance of an application 120 is installed in a terminal device 130. A user 132 may interact with the application 120 via an attachment device of the terminal device 130. Similarly, the user 132 may interact with the application 120 via an attachment device of the terminal device 130.

In some embodiments, the application 120 may be any suitable application that may provide a wide variety of media contents for the user 132. As an example, the application 120 may be an application viewing a media content class. As a further example, the application 120 may be an instant messaging (IM) application. It would be appreciated that the above is merely an example with respect to the application 120 and is not intended to be limiting, and the application 120 may be any suitable type of application that provides media contents. In the environment 100 of FIG. 1, if the application 120 is active, the terminal device 130 may present the interface 150 of the application 120. The interface 150 may include various pages that may be provided by the application 120, such as a media content presentation page, a media content playing page, or the like.

In some embodiments, the terminal device 130 communicates with the server 110 to enable provisioning of services to the application 120. The terminal device 130 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 130 may also support any type of interface for a user (such as a “wearable” circuit, etc. ). The server 110 may be various types of computing systems/servers capable of providing computing power, including, but not limited to, mainframes, edge computing nodes, computing devices in a cloud environment, and the like.

It would be appreciated that the structures and functions of the various elements in the environment 100 are described for example purposes only and do not imply any limitation to the scope of the present disclosure.

Various example implementations of the present disclosure will be described in detail below with reference to the accompanying drawings. Hereinafter, example embodiments will be described primarily with respect to the server 110. It would be appreciated that the actions described with respect to the server 110 may be performed by the terminal device 130 in cooperation with the server 110. In some embodiments, in a scenario executed by the terminal device 130 in cooperation with the server 110, the terminal device 130 may request the server (for example, the server 130) to provide the media content to be presented, and receive the determined media content from the server for presentation into the target page.

In some embodiments, the terminal device 130 may also send the request for presenting the media content to the server (for example, the server 110). The server 110 may determine the reference information and the upper context information based on the obtained request. Further, the server 110 may determine, based on at least one of the determined context information and the reference information, the volume that the second media content to be presented needs to be configured. Further, the server 130 sends the volume of the second media content to be presented to the terminal device 130. Subsequently, the terminal device 130 presents the second media content and configures the volume of the second media content.

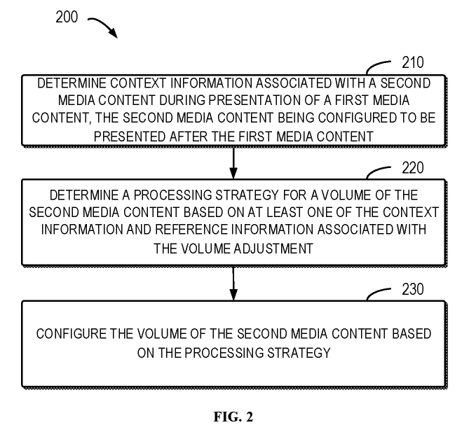

Various example implementations of the present disclosure will be described in detail below with reference to FIG. 2. FIG. 2 shows a flowchart of a process 200 for volume adjustment according to some embodiments of the present disclosure. Example embodiments will be described below with reference to FIG. 1.

In some embodiments, the terminal device 130 may present the plurality of media contents (for example, the first media content and the second media content) in the interface, and the terminal device 130 may play the media content in the interface. In some embodiments, the media content may be video, a dynamically played set of images, an image, or the like that may be played. The media content may be provided in any suitable application or platform of the terminal device 130.

In some scenarios, the media content may be presented in an information stream, and the user 132 may slide up and down to view the media content. In other scenarios, the media content may be presented in different media (e.g., television, radio, etc. ), the user 132 may view the next media content based on television media, station media, and the like. The foregoing scenario is merely for example, and this is not limited in the present disclosure. For the foregoing different scenarios, according to the method of the present disclosure, for the currently presented media content (for example, the N media content), the processing strategy of the volume of the next media content (for example, N + 1 media content) may be predicted, so that the volume of the next media content is configured in advance, and the experience feeling of the user 132 is improved. The process for adjusting the volume of the present disclosure will be described in detail below with reference to FIG. 2.

At block 210, the server 110 determines context information associated with a second media content during presentation of a first media content. In some embodiments, the second media content is configured to be presented after the first media content. The server 110 may determine context information associated with a next media content (also referred to as “the second media content”) during presentation of the first media content.

At block 220, the server 110 determines a processing strategy for a volume of the second media content based on at least one of the context information and reference information associated with the volume adjustment. In some embodiments, the server 110 may invoke the classification model to determine a processing strategy for the volume of the second media content based on at least one of context information associated with the second media content and reference information associated with the volume adjustment.

In some embodiments, the server 110 may further determine a processing strategy for the volume of the second media content based on at least one of the context information associated with the second media content and the reference information associated with the volume adjustment. How the server 110 invokes the classification model or determines the processing strategy of the volume of the second media content based on one or more rules will be described in detail below.

At block 230, the server 110 configures the volume of the second media content based on the processing strategy. It would be appreciated that the server 110 may also send the processing strategy for the volume of the second media content to the terminal device 130, and the terminal device 130 configures the volume of the second media content. In some embodiments, the server 110 may configure the volume of the second media content based on its determined processing strategy. In some embodiments, the server 110 may configure the volume of the second media content in a predetermined range based on the processing strategy.

In some embodiments, the server 110 may configure, based on the processing strategy, the volume of the second media content in accordance with a predetermined range pre-configured by the management user. For example, when the server 110 determines that the processing strategy for the second media content is the upregulated volume, the volume of the second media content may be configured in accordance with a predetermined range preconfigured by the administrator (for example, up to two volumes). For a further example, when the server 110 determines that the processing strategy for the second media content is the down-regulation volume, the volume of the second media content may be configured in accordance with a predetermined range pre-configured by the administrator (for example, down-regulation of the two-compartment volume).

In some embodiments, the server 110 may further configure the volume of the second media content based on the predetermined range determined by the context information via the classification model based on the processing strategy. For example, when the server 110 determines that the processing strategy for the second media content is the upregulated volume, the volume of the second media content may be configured based on a predetermined range (e.g., up to a bin volume) determined by the classification model based on the context information. For a further example, when the server 110 determines that the processing strategy for the second media content is to decrease the volume, the volume of the second media content may be configured based on a predetermined range (for example, a bin volume) determined by the classification model based on the context information.

Therefore, based on at least one of the context information and the reference information, the volume required by the user at the next media content may be predicted in advance, so that the user does not need to adjust the volume automatically when watching the next media content. Further, the user may not be affected by volume differences between different media content, thereby improving user experience.

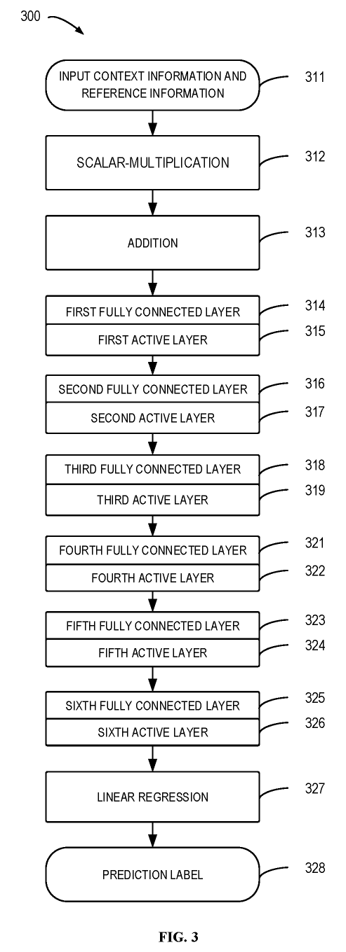

The following is a processing strategy that facilitates understanding how the server 110 invokes the classification model to determine the volume of the second media content with reference to FIG. 3.

It would be appreciated that, in some embodiments, in a scenario in which the server 110 invokes the classification model to determine the processing strategy of the volume of the second media content. The context information associated with the second media content may include interactions associated with a first historical media content presented before the second media content is presented. For example, the context information may include an interaction of the first N media contents before the second media content is presented (e.g., a user interaction with a comment, like, collects, etc. for the first N media contents).

In some embodiments, the context information associated with the second media content may include interactions associated with the second historical media content presented within a first period. For example, the context information may include user interactions with the plurality of media contents for the first period (e.g., historical 7-14 days) (e.g., a user interacting with comments, likes, collects, etc. of the plurality of media contents within the history 7-14 days). In some embodiments, the context information associated with the second media content may include label information associated with the second media content. In some examples, the label information associated with the second media content may indicate a category of the second media content. For example, the second media content may belong to a category of delicious media content, news media content, social media content, game media content, and the like. This is merely example, which is not limited in the present disclosure.

In some embodiments, the context information associated with the second media content may include device information for presenting the second media content. In some examples, the required volumes are different for devices with different operating systems. In some embodiments, the context information associated with the second media content may further include information of a volume range of the second media content. In some examples, different media contents have respective volume ranges, volume features, and the like. In some examples, for a case where the volume difference between the front and back media contents (for example, video A and video B) is large, the range of the volume of the B media content may be configured by advancing the determined processing strategy to avoid the user 132 from being affected (for example, the sound of the video B is too large).

In some embodiments, the server 110 may determine the range of the volume of the video B from a plurality of videos in an information stream (e.g., a video stream). In some embodiments, the server 110 may also invoke the model to determine the range of the volume of the video B. In some examples, the server 110 may also determine the range of the volume of the video B based on the historical volume of the user associated with the video B.

Accordingly, the reference information associated with the volume adjustment may include a first historical processing strategy for the volume of the first historical media content. In some examples, the reference information may include the first historical processing strategy for volume of the first N media contents before the second media content is presented. That is, the volume adjustment of the first N media contents. In some embodiments, the reference information associated with the volume adjustment may further include a second historical processing strategy for the volume of the second historical media content. In some examples, the reference information may include historical processing strategies for a plurality of media contents viewed by the user within the first period (e.g., historical 7-14 days). That is, the user information about the playing parameters of the plurality of media contents in the first period (e.g., the historical 7-14 days).

In some embodiments, the server 110 may input the context information and the reference information into a classification model to obtain a prediction label for configuring the volume of the second media content. In some embodiments, the prediction label indicates a probability that the volume of the second media content is configured based on a processing strategy indicated by the prediction label. In some examples, the server 110 may input the context information and the reference information into the classification model, and further obtain a plurality of prediction labels output by the classification model. The probability that the volume of the second media content is configured based on the processing strategy indicated by the prediction label is indicated for any prediction label of the plurality of prediction labels.

In some embodiments, the classification model may be a Multilayer Perceptron (MLP), and may be composed of an input layer, a plurality of Fully Connected Layers (FC layers), a plurality of activation layers, an output layer, and the like. The multi-layer perceptron is a neural network model, which is a feedforward neural network and may be used for solving the problems of classification and regression. The fully connected layer (FC layer) may map all features of the input data (i.e., context information, reference information) to the output layer for classification or regression. The activation layer may be a non-linear mapping layer for increasing the nonlinear expression capability of the entire network. The activation layer may be composed of an activation function, and the output result is linearly mapped to correct the defect of the network. For example, the output result of the fully connected layer is linearly mapped.

How to output the prediction label via the classification model is described below with reference to FIG. 3. FIG. 3 shows a schematic diagram of an example architecture 300 for performing volume adjustment with a classification model according to some embodiments of the present disclosure. Referring to the example architecture 300 shown in FIG. 3, the classification model may perform a scalar-multiplication operation 312 and an addition operation 313 on the input context information and reference information 311. The classification model inputs the processed context information and reference information 311 into a first fully connected layer 314, a first active layer 315, a second fully connected layer 316, a second active layer 317, a third fully connected layer 318, a third active layer 319, a fourth fully connected layer 321, a fourth active layer 322, a fifth fully connected layer 323, a fifth active layer 324, and a sixth fully connected layer 325, a sixth active layer 326 to map all features of the context information and the reference information 311 to the output layer. It would be appreciated that some of the fully connected layers may have different functions. Further, the classification model may input the data processed through these fully connected layers into a linear regression model 327 to obtain a plurality of prediction labels 328. It would be appreciated that the architecture of the classification model shown in FIG. 3 is merely example and is not intended to be limiting. The classification model in the embodiments of the present disclosure may adopt any suitable architecture.

In some embodiments, the strategy is processed for a plurality of predetermined processing strategies, such as a first processing strategy (e.g., to increase a volume of the second media content), a second processing strategy (e.g., to increase a volume of the second media content), a third processing strategy (e.g., a volume of the second media content being not adjusted), a fourth processing strategy (e.g., adjusting a volume of the second media content, but a volume of the second media content unchanged), and/or the like.

For the case of the plurality of processing strategies described above. A first prediction label of the plurality of prediction labels may indicate a probability that the second media content may be configured as a first processing strategy. A second prediction label of the plurality of prediction labels may indicate a probability that the second media content may be configured as a second processing strategy. A third prediction label of the plurality of prediction labels may indicate a probability that the second media content may be configured as a third processing strategy. A fourth prediction label of the plurality of prediction labels may indicate a probability that the second media content may be configured as a fourth processing strategy.

In some embodiments, the server 110 may select a prediction label greater than a probability threshold from the plurality of prediction labels based on a predetermined probability threshold. Further, the server 110 may configure the volume of the second media content based on a processing strategy indicated by the prediction label. In some examples, the server 110 may configure the volume of the second media content based on the processing strategy indicated from the prediction label selected from the plurality of prediction labels. With continued reference to the above example, if the probability threshold is 0.2 (or any other suitable value), if the first prediction label output by the classification model is 0.8 (or any other suitable value), the second prediction label is 0.05 (or any other suitable value), and the third prediction label is 0.05 (or any other suitable value), and the fourth prediction label is 0.1 (or any other suitable value), the final output of the classification model may be determined as the first prediction label. That is, the volume of the second media content is increased, for example, up to two grids.

Therefore, the volume of the second media content may be predicted more flexibly, finely and accurately through the classification model, and the requirement of the user on the volume of the second media content is satisfied. Further, the user may not need to adjust the volume automatically when watching the next media content.

The following continues to describe how the server 110 determines the processing strategy of the volume of the second media content according to one or more rules.

In some embodiments, the server 110 may determine a volume processing strategy for the second media content based on a content category of the second media content and a content category of the first media content included in the context information. For example, when the first media content is media content with a low volume demand (for example, a news media content), and the second media content is media content with a high volume demand (for example, a game media content). The server 110 may decrease the volume of the second media content.

For a further example, when the first media content is media content with a low volume demand (for example, a news media content), and the second media content is also media content with a low volume demand (for example, a delicious media content). The server 110 may not adjust the volume of the second media content. In addition, when the first media content is a media content (for example, a news media content) with a low volume demand, and the second media content is a media content (for example, a game media content) with a high volume demand. The server 110 may adjust the volume of the second media content to adapt to the media content.

In some embodiments, the server 110 may determine a processing strategy for the volume of the second media content according to respective content categories of different media contents. For example, the media content for the delicious category may increase the volume of the media content by 5%. The volume of the media content may be increased by 5% for the news media content. The media content for the dance type may decrease the volume of the media content by 5%. The volume of the media content may be increased by 10% for the music media content. The media content for the game may increase the volume of the media content by 10%. However, these are merely example, which is not limited in the present disclosure.

In some embodiments, the server 110 may determine the volume processing strategy for the second media content based on the first historical processing strategy and the second historical processing strategy included in the reference information. In some examples, the server 110 may determine the processing strategy of the volume of the current media content based on the processing strategy of the volume of the first N media contents of the current media content by the user 132. The server 110 may also determine the processing strategy of the volume of the second media content based on the processing strategy of the volume of the plurality of media contents for a period of time (e.g., 7-14 days) by the user 132. It would be appreciated that the server 110 may determine the processing strategy of the volume of the second media content according to the user's preference.

In some embodiments, the server 110 may determine the user group based on the first historical processing strategy and the second historical processing strategy. In some embodiments, the server 110 may refer to some users' historical adjustment strategies for a plurality of media contents, and determine these users as different user groups. In some examples, the server 110 may determine a group of users whose number of volume increases is less than the number of volume decreases. The server 110 may determine a group of users who rarely adjust the volume. The server 110 may further determine a group of users whose number of volume decreases is less than the number of volume increases. Additionally, the server 110 may further determine a group of users who adjust the volume according to their needs. For example, older users tend to increase the volume, while younger users tend to decrease the volume. For a further example, users who like rock music tend to increase the volume of rock music media content when watching it, while users who do not like rock music tend to decrease the volume of such media content when watching it, and so on. The above examples are merely example, which is not limited in the present disclosure.

Further, the server 110 determines the adjustment strategy for the volume of the second media content based on the preferences of different users. For example, if user A frequently adjusts the volume of the media content, the volume of the second media content may be adjusted. If user B frequently decreases the volume of the media content, the volume of the second media content may be decreased.

In some embodiments, the server 110 may further determine a processing strategy for the second media content based on the content category of the media content and the preference of the user. For example, in a scenario in which the first media content is presented, and it is determined that the second media content is XX media content. If it is determined that user A frequently adjusts the volume of the media content when browsing the XX media content, the server 110 may adjust the volume of the XX media content. For a further example, in a scenario of presenting the first media content and determining that the second media content is the XX media content. If it is determined that user B frequently does not adjust the volume of the media content when browsing the XX media content, the server 110 may not adjust the volume of the XX media content.

In some embodiments, the server 110 may further determine a processing strategy for the volume of the second media content based on the device information included in the context information for presenting the second media content. In some examples, the frequency of adjusting the volume of the media content in the device having the first operating system is higher than the frequency of adjusting the volume of the media content by the device having the second operating system. If the server 110 determines that the device currently presenting the media content has the first operating system, the server 110 may adjust the volume of the media content as required. If the server 110 determines that the device currently presenting the media content has the second operating system, the server 110 may not adjust the volume of the media content.

In some embodiments, the server 110 may further determine a processing strategy for the volume of the second media content based on the device information and the content category of the media content. With continued reference to the foregoing example scenario, if the server 110 determines that the device presenting the second media content has the first operating system, and the second media content is media content that requires a high volume, the volume of the second media content may be adjusted to be high. If the server 110 determines that the device presenting the second media content has the first operating system, and the second media content is media content that requires a low volume, the volume of the second media content may be decreased.

In some embodiments, the server 110 may further determine a processing strategy for the volume of the second media content based on the device information and the user preference. With continued reference to the foregoing example scenario, if it is determined that the device presenting the second media content is provided with the first operating system, and the volume of the media content is frequently adjusted for user A, the volume of the second media content may be adjusted to be high. If the server 110 determines that the device presenting the second media content has the second operating system and does not adjust the volume of the media content frequently for the A user, the server 110 may not adjust the volume of the second media content.

In some embodiments, the server 110 may further determine a processing strategy for the volume of the second media content based on device information, user preference, and a content category of a media content. With continued reference to the foregoing example scenario, if the server 110 determines that the device presenting the second media content has the first operating system, and the volume of the media content that is frequently category XX is frequently adjusted for user A, the volume of the second media content that is the category XX of media content may be adjusted to be high. If the server 110 determines that the device presenting the second media content has the second operating system and does not adjust the volume of the media content of the category XX frequently for user A, the server 110 may not adjust the volume of the second media content of the media content of the XX category.

In summary, the present disclosure may predict the required volume of the user at the next media content in advance based on at least one of the context information and the reference information, so that the user does not need to adjust the volume automatically when watching the next media content. Further, the user may not be affected by volume differences between different media content, thereby improving user experience.

### Example Apparatus and Device

Embodiments of the present disclosure also provide a corresponding apparatus for implementing the above method or process.

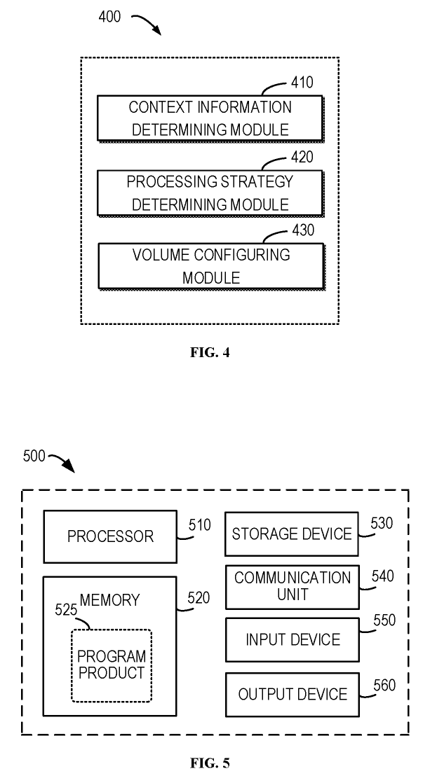

FIG. 4 shows a schematic structural block diagram of an apparatus 400 for volume adjustment according to some embodiments of the present disclosure. The apparatus 400 may be implemented or included in the server 110. The various modules/components in the apparatus 400 may be implemented by hardware, software, firmware, or any combination thereof.

As shown in FIG. 4, the apparatus 400 includes a context information determining module 410 configured to determine context information associated with a second media content during presentation of a first media content, the second media content being configured to be presented after the first media content; a processing strategy determining module 420 configured to determine a processing strategy for a volume of the second media content based on at least one of the context information and reference information associated with the volume adjustment; and a volume configuring module 430 configured to configure the volume of the second media content based on the processing strategy.

In some embodiments, the volume configuring module 430 is further configured to input the context information and the reference information into a classification model to obtain a prediction label for configuring the volume of the second media content, the prediction label indicating a probability that the volume of the second media content is configured based on a processing strategy indicated by the prediction label; and configure the volume of the second media content based on the processing strategy indicated by the prediction label.

In some embodiments, the context information includes at least one of: interaction associated with a first historical media content presented before the second media content is presented, interaction associated with a second historical media content presented within a first period, label information associated with the second media content, device information for presenting the second media content, or information of a volume range of the second media content.

In some embodiments, the reference information includes at least one of: a first historical processing strategy for a volume of the first historical media content, or a second historical processing strategy for a volume of the second historical media content.

In some embodiments, the processing strategy determining module 420 is further configured to determine a volume processing strategy for the second media content based on a content category of the second media content and a content category of the first media content included in the context information.

In some embodiments, the processing strategy determining module 420 is further configured to determine a volume processing strategy for the second media content based on device information included in the context information for presenting the second media content.

In some embodiments, the processing strategy determining module 420 is further configured to determine a volume processing strategy for the second media content based on a first historical processing strategy and a second historical processing strategy included in the reference information.

In some embodiments, the processing strategy determining module 420 is further configured to configure, based on the processing strategy, the volume of the second media content in accordance with a predetermined range, and the predetermined range is determined by: pre-configuring via a management user, or determining via a classification model based on the context information.

The units and/or modules included in the apparatus 400 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 400 may be implemented, at least in part, by one or more hardware logic components. By way of example and not limitation, example types of hardware logic components that may be used include Field Programmable Gate Arrays (FPGAs), Application Specific Integrated Circuits (ASICs), Application Specific Standard Products (ASSPs), System on Chips (SOCs), Complex Programmable Logic Devices (CPLDs), and so on.

It would be appreciated that one or more of the above methods may be performed by a suitable electronic device or a combination of electronic devices. Such electronic devices or combinations of electronic devices may include, for example, the server 110 in FIG. 1.

FIG. 5 illustrates a block diagram of an electronic device 500 in which one or more embodiments of the present disclosure may be implemented. It would be appreciated that the electronic device 500 illustrated in FIG. 5 is merely example and would not constitute any limitation on the functionality and scope of the embodiments described herein. The electronic device 500 shown in FIG. 5 may be configured to implement the server 110 in FIG. 1.

As shown in FIG. 5, the electronic device 500 is in a form of a general-purpose electronic device. Components of the electronic device 500 may include, but are not limited to, one or more processors 510 or processing units, memory 520, storage device 530, one or more communication units 540, one or more input devices 550, and one or more output devices 560. The processor 510 may be an actual or virtual processor and is capable of performing various processes based on programs stored in the memory 520. In a multiprocessor system, a plurality of processors performs computer-executable instructions in parallel to improve the parallel processing capability of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a disk, or any other medium that may be capable of storing information and/or data and may be accessible within the electronic device 500.

The electronic device 500 may further include additional removable/non-removable, volatile/non-volatile storage media. Although not shown in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not shown), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for volume adjustment, comprising:
determining context information associated with a second media content during presentation of a first media content, the second media content being configured to be presented after the first media content;
determining a processing strategy for a volume of the second media content based on at least one of the context information and reference information associated with the volume adjustment; and
configuring the volume of the second media content based on the processing strategy.

2. The method of claim 1, wherein configuring the volume of the second media content comprises:
inputting the context information and the reference information into a classification model to obtain a prediction label for configuring the volume of the second media content, the prediction label indicating a probability that the volume of the second media content is configured based on a processing strategy indicated by the prediction label; and
configuring the volume of the second media content based on the processing strategy indicated by the prediction label.

3. The method of claim 2, wherein the context information comprises at least one of:
interaction associated with a first historical media content presented before the second media content is presented,
interaction associated with a second historical media content presented within a first period,
label information associated with the second media content,
device information for presenting the second media content, or
information of a volume range of the second media content.

4. The method of claim 2, wherein the reference information comprises at least one of:
a first historical processing strategy for a volume of the first historical media content, or
a second historical processing strategy for a volume of the second historical media content.

5. The method of claim 1, wherein determining the processing strategy for the volume of the second media content comprises:
determining a volume processing strategy for the second media content based on a content category of the second media content and a content category of the first media content comprised in the context information.

6. The method of claim 1, wherein determining the processing strategy for the volume of the second media content comprises:
determining a volume processing strategy for the second media content based on device information comprised in the context information for presenting the second media content.

7. The method of claim 1, wherein determining the processing strategy for the volume of the second media content comprises:
determining a volume processing strategy for the second media content based on a first historical processing strategy and a second historical processing strategy comprised in the reference information.

8. The method of claim 1, wherein configuring the volume of the second media content comprises:
configuring, based on the processing strategy, the volume of the second media content in accordance with a predetermined range, and the predetermined range is determined by:
pre-configuring via a management user, or
determining via a classification model based on the context information.

9. An electronic device, comprising:
at least one processor; and
at least one memory coupled to the at least one processor and storing instructions for execution by the at least one processor, the instructions, when executed by the at least one processor, causing the electronic device to perform acts comprising:
determining context information associated with a second media content during presentation of a first media content, the second media content being configured to be presented after the first media content;
determining a processing strategy for a volume of the second media content based on at least one of the context information and reference information associated with the volume adjustment; and
configuring the volume of the second media content based on the processing strategy.

10. The electronic device of claim 9, wherein configuring the volume of the second media content comprises:
inputting the context information and the reference information into a classification model to obtain a prediction label for configuring the volume of the second media content, the prediction label indicating a probability that the volume of the second media content is configured based on a processing strategy indicated by the prediction label; and
configuring the volume of the second media content based on the processing strategy indicated by the prediction label.

11. The electronic device of claim 10, wherein the context information comprises at least one of:
interaction associated with a first historical media content presented before the second media content is presented,
interaction associated with a second historical media content presented within a first period,
label information associated with the second media content,
device information for presenting the second media content, or
information of a volume range of the second media content.

12. The electronic device of claim 10, wherein the reference information comprises at least one of:
a first historical processing strategy for a volume of the first historical media content, or
a second historical processing strategy for a volume of the second historical media content.

13. The electronic device of claim 9, wherein determining the processing strategy for the volume of the second media content comprises:
determining a volume processing strategy for the second media content based on a content category of the second media content and a content category of the first media content comprised in the context information.

14. The electronic device of claim 9, wherein determining the processing strategy for the volume of the second media content comprises:
determining a volume processing strategy for the second media content based on device information comprised in the context information for presenting the second media content.

15. The electronic device of claim 9, wherein determining the processing strategy for the volume of the second media content comprises:
determining a volume processing strategy for the second media content based on a first historical processing strategy and a second historical processing strategy comprised in the reference information.

16. The electronic device of claim 9, wherein configuring the volume of the second media content comprises:
configuring, based on the processing strategy, the volume of the second media content in accordance with a predetermined range, and the predetermined range is determined by:
pre-configuring via a management user, or
determining via a classification model based on the context information.

17. A non-transitory computer-readable storage medium having computer-executable instructions stored thereon, the instructions being executable by a processor to perform acts comprising:
determining context information associated with a second media content during presentation of a first media content, the second media content being configured to be presented after the first media content;
determining a processing strategy for a volume of the second media content based on at least one of the context information and reference information associated with the volume adjustment; and
configuring the volume of the second media content based on the processing strategy.

18. The non-transitory computer-readable storage medium of claim 17, wherein configuring the volume of the second media content comprises:
inputting the context information and the reference information into a classification model to obtain a prediction label for configuring the volume of the second media content, the prediction label indicating a probability that the volume of the second media content is configured based on a processing strategy indicated by the prediction label; and
configuring the volume of the second media content based on the processing strategy indicated by the prediction label.

19. The non-transitory computer-readable storage medium of claim 18, wherein the context information comprises at least one of:
interaction associated with a first historical media content presented before the second media content is presented,
interaction associated with a second historical media content presented within a first period,
label information associated with the second media content,
device information for presenting the second media content, or
information of a volume range of the second media content.

20. The non-transitory computer-readable storage medium of claim 18, wherein the reference information comprises at least one of:
a first historical processing strategy for a volume of the first historical media content, or
a second historical processing strategy for a volume of the second historical media content.
